(19) United States
(12) Patent Application Publication
(10) Pub. No.: US 2025/0375712 A1
(43) Pub. Date: Dec. 11, 2025

(54) PRIVACY PRESERVING RESPONSIBLE GAMING

(71) Applicant: IGT, Las Vegas, NV (US)

(72) Inventors: Yizhao Zhu, Macau (CN); Kelvin Ng, Macau (CN)

(21) Appl. No.: 18/740,219

(22) Filed: Jun. 11, 2024

(51) Int. Cl. A63F 13/71

(52) U.S. Cl. CPC A63F 13/71

(57) ABSTRACT

Embodiments of the present disclosure are directed to applying responsible gaming in a gaming environment while maintaining privacy for player information. Embodiments of the present disclosure utilize Oblivious Transfer (OT) and Private Set Intersection (PSI) protocols to address privacy concerns of responsible gaming systems. More specifically, embodiments address privacy concerns related to player global limits and banned player list queries and responses utilizing OT and PSI protocols. Embodiments not only addresses privacy concerns between the query user and the centralized database server but also mitigates privacy concerns between the query user and Certificate Authority (CA) by incorporating blind RSA signature scheme.

### BACKGROUND

The present disclosure is generally directed to responsible gaming and more particularly to preserving privacy while applying responsible gaming in a gaming environment.

Responsible gaming aims at maintaining the integrity and sustainability of the gaming industry. However, the exchange of sensitive data, such as player and gaming related information, among different parties raises significant privacy concerns, and safeguarding privacy becomes a top priority consideration throughout the design and implementation of responsible gaming systems. Hence there is a need in the art for improved methods and systems for applying responsible gaming in a gaming environment.

### BRIEF SUMMARY

Embodiments of the present disclosure are directed to applying responsible gaming in a gaming environment while maintaining privacy for player information. According to one embodiment, a method for preserving privacy in a responsible gaming system can comprise maintaining a first set of responsible gaming information related to a first set of players and maintaining a second set of responsible gaming information related to a second set of players. For example, the first set of responsible gaming information can comprise gaming limitation information for each player of the first set of players and the second set of responsible gaming information can comprise a banned player list comprising the second set of players.

A first query of a first query type can be received. The first query can request information from the first set of responsible gaming information using a first privacy-preserving protocol. For example, the first privacy-preserving protocol can comprise Oblivious Transfer (OT) protocol. A response can be made to the first query with a first answer using the first privacy-preserving protocol. The first answer can comprise information from the first set of responsible gaming information.

A second query of a second type can be received. The second query can request information from the second set of responsible gaming information using a second protocol. For example, the second privacy-preserving protocol comprises Private Set Intersection (PSI) protocol. A response can be made to the second query with a second answer using the second privacy-preserving protocol. The second answer can comprise information from the second set of responsible gaming information. In some cases, the first query, the first answer, the second query, and the second answer can be signed with a key issued by a certificate authority. For example, the first answer, the second query, and the second answer can be signed using Blind Rivest–Shamir–Adleman (RSA) encryption.

According to another embodiment, a system can comprise a processor and a memory coupled with and readable by the processor and storing therein a set of instructions which, when executed by the processor, causes the processor to maintain a first set of responsible gaming information related to a first set of players and maintain a second set of responsible gaming information related to a second set of players. For example, the first set of responsible gaming information can comprise gaming limitation information for each player of the first set of players and the second set of responsible gaming information can comprise a banned player list comprising the second set of players.

The instructions can further cause the processor to receive a first query of a first query type requesting information from the first set of responsible gaming information using a first privacy-preserving protocol and respond to the first query with a first answer using the first privacy-preserving protocol. For example, the first privacy-preserving protocol can comprise OT protocol. The first answer can comprise information from the first set of responsible gaming information.

The instructions can further cause the processor to receive a second query of a second type requesting information from the second set of responsible gaming information using a second protocol and respond to the second query with a second answer using the second privacy-preserving protocol. For example, the second privacy-preserving protocol can comprise PSI protocol. The second answer can comprise information from the second set of responsible gaming information. In some cases, the instructions can further cause the processor to sign the first query, the first answer, the second query, and the second answer with a key issued by a certificate authority. For example, the first query, the first answer, the second query, and the second answer can be signed using RSA encryption.

According to another embodiment, a gaming system can comprise a communication interface, a processor coupled with the communication interface, and a memory coupled with and readable by the processor and storing therein a set of instructions which, when executed by the processor, causes the processor to issue, via the communication interface, a first query of a first query type to a responsible gaming system. The first query can be related to a first set of players and can request information from a first set of responsible gaming information using a first privacy-preserving protocol. For example, the first set of responsible gaming information can comprise gaming limitation information for each player of the first set of players and the first privacy-preserving protocol can comprise OT protocol. The instructions can further cause the processor to receive a first answer from the responsible gaming system via the communication interface using the first privacy-preserving protocol, the first answer comprising information from the first set of responsible gaming information.

The instructions can further cause the processor to issue, via the communication interface, a second query of a second type to the responsible gaming system. The second query can be relate to a second set of players and can request information from the second set of responsible gaming information using a second protocol. For example, the second set of responsible gaming information can comprise a banned player list comprising the second set of players and the second privacy-preserving protocol can comprise PSI protocol. The instructions can further cause the processor to receive a second answer from the responsible gaming system via the communication interface using the second privacy-preserving protocol, the second answer comprising information from the second set of responsible gaming information. In some cases, the first query, the first answer, the second query, and the second answer can be signed with a key issued by a certificate authority, e.g., using RSA encryption. Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which responsible gaming can be applied according to one embodiment of the present disclosure.

FIG. 2 is a block diagram illustrating an example of applying responsible gaming in a gaming environment while maintaining privacy for player information according to one embodiment of the present disclosure.

FIG. 3 is a block diagram illustrating and example of applying responsible gaming in a gaming environment while maintaining privacy for player information according to another embodiment of the present disclosure.

FIG. 4 is a block diagram illustrating additional details of components of an exemplary responsible gaming system according to one embodiment of the present disclosure.

FIG. 5 is a block diagram illustrating additional details of components of an exemplary gaming system according to one embodiment of the present disclosure.

FIG. 6 is a flowchart illustrating an exemplary process for applying responsible gaming in a gaming environment while maintaining privacy for player information according to one embodiment of the present disclosure.

FIG. 7 is a flowchart illustrating an exemplary process for applying responsible gaming in a gaming environment while maintaining privacy for player information according to another embodiment of the present disclosure.

### DETAILED DESCRIPTION

Embodiments of the present disclosure are directed to applying responsible gaming in a gaming environment while maintaining privacy for player information. Embodiments of the present disclosure utilize Oblivious Transfer (OT) and Private Set Intersection (PSI) protocols to address privacy concerns of responsible gaming systems. More specifically, embodiments address privacy concerns related to player global limits and banned player list queries and responses utilizing OT and PSI protocols. Embodiments not only addresses privacy concerns between the query user and the centralized database server but also mitigates privacy concerns between the query user and Certificate Authority (CA) by incorporating blind RSA signature scheme.

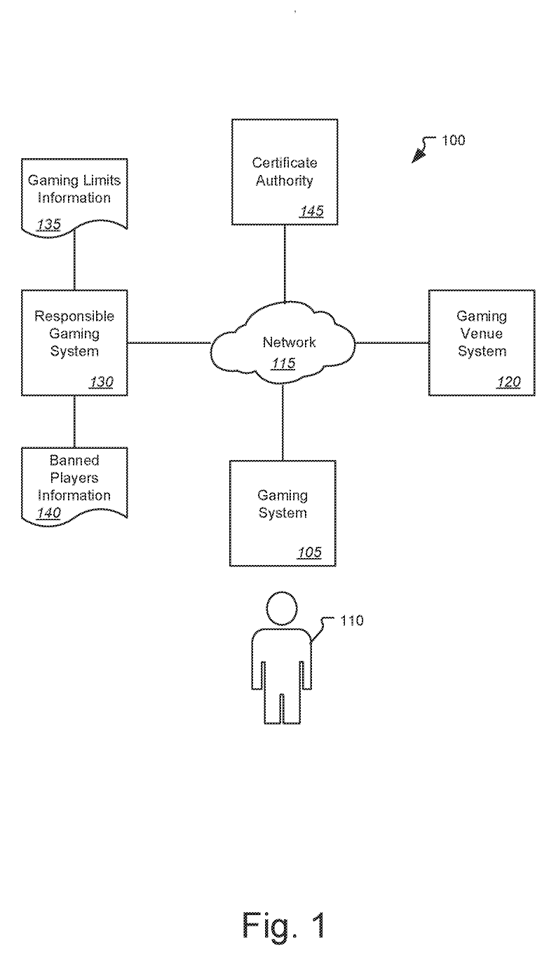

FIG. 1 is a block diagram illustrating an exemplary environment in which responsible gaming can be applied according to one embodiment of the present disclosure. As illustrated in this example, the environment 100 can comprise a gaming system 105 such as any Electronic Gaming Machine (EGM), kiosk, or similar gaming system as may be found in a casino or other gaming venue. The gaming system 105 can execute any of a variety of electronic games including, but not limited to slots, video slots, video poker, keno, etc. to be played by a player 110. The gaming system 105 can be coupled with a communication network 115. The communication network 115 can comprise any one or more wired and/or wireless, local-area and/or wide-area networks as known in the art including, but not limited to, the Internet.

Also coupled with the communication network 115 can be one or more gaming venue systems 120 and a responsible gaming system 130. The gaming venue system 120 can comprise any one or more servers and/or other computing devices such as commonly used to manage gaming systems 105 and other systems in a casino or other gaming venue. Similarly, the responsible gaming system 125 can comprise one or more servers and/or other computing devices as known in the art and used to provide responsible gaming oversight and functions within the gaming venue.

The responsible gaming system 130 can maintain various sets of information related to players and limitations for those players. For example, the responsible gaming system 130 can maintain a set of gaming limitations information 135 which defines for each player identified in a table or list one or more limits to be applied, e.g., a gambling limit, when that player is playing a game in a casino of gaming environment. The responsible gaming system 130 can also maintain a set of banned players information 140 which lists a set of players which are, for various reasons, prohibited or barred from gambling in a casino or other gaming environment.

Embodiments of the present disclosure are directed to allowing the responsible gaming system to respond to queries of the gaming limitations information 135 and/or banned players information 140 from the gaming venue system 120 and/or gaming system 105 while maintaining the privacy of both the requesting gaming venue system 120 and/or gaming system 105 and the gaming limitations information 135 and banned players information 140. As will be described, different types of queries, e.g., a query of the gaming limitations information and a query of the banned players list can be made and answered between a requesting system such as the gaming venue system 120 or gaming system 105 using different privacy preserving protocols. Specifically, query of the gaming limitations information 135 can be conducted using the OT protocol and a query of the banned players list can be made using the PST protocol. Private Information Retrieval (PIR) can be used to retrieve the requested information without revealing the message index to the database, preserving privacy. PSI protocol is a cryptographic protocol that allows two parties, each holding a private set of data, to determine the intersection of their sets without revealing any additional information about the non-matching elements.

According to one embodiment, the environment 100 can further comprise a certificate authority 145 coupled with the communication network. As known in the art, a certificate authority is a trusted third-party system that stores, signs, and issues digital certificates. According to one embodiment, queries made by the requesting systems such as the gaming venue system 120 and gaming system 105 and responses made by the responsible gaming system 130 can be signed with certificates issued by the certificate authority 145. For example, these exchanges can be signed using a blind Rivest–Shamir–Adleman (RSA) public key encryption scheme utilizing certificates issued by the certificate authority 145. Blind RSA signatures enable message signing without revealing the content of the message, thereby allowing users to obtain valid RSA signatures while keeping the signer oblivious to the message details.

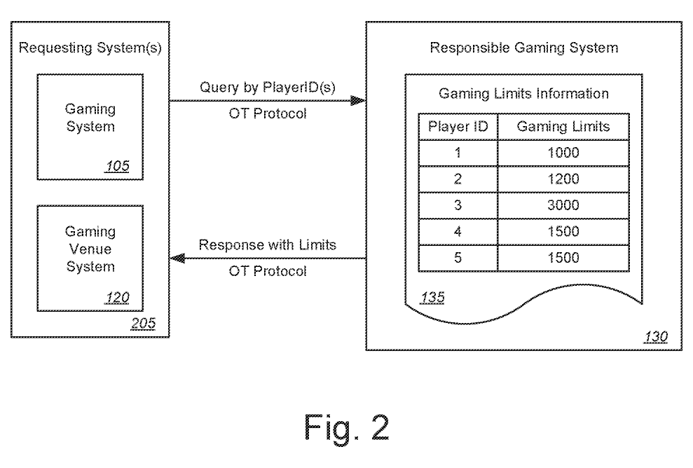

FIG. 2 is a block diagram illustrating an example of applying responsible gaming in a gaming environment while maintaining privacy for player information according to one embodiment of the present disclosure. More specifically, this example illustrates the handling of a first query type, i.e., a query involving retrieval of the current global gaming limits for a player based on a player identifier (ID). In this case the OT protocol can be used between the requesting systems 205, i.e., the gaming system 105 or gaming venue system 120, and the responsible gaming system 130. Here, the responsible gaming system 130 acts as the OT sender while the requesting system(s) 205 act as the OT receiver.

In this example, the requesting system(s) 205 can issue a query for a particular player’s limitation information based on the player’s ID. The responsible gaming system 130 can use private set intersection to identify gaming limitation information for the player while keeping the player ID private. The responsible gaming system 130 can then respond to the requesting system(s) 205 with the appropriate gaming limitations information for that player. As noted above, the query and response can signed using a blind RSA signature.

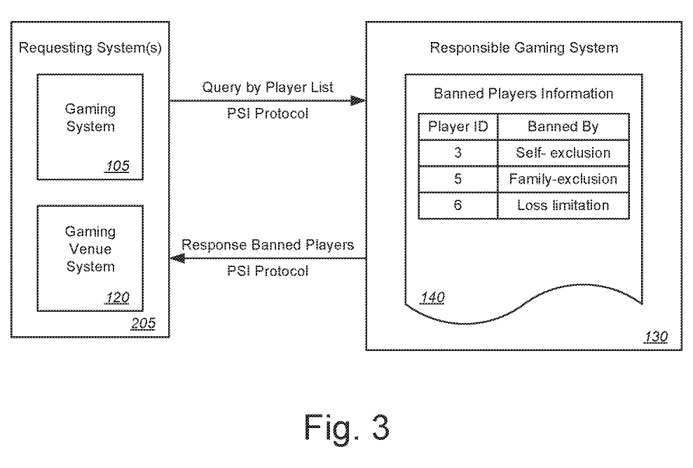

FIG. 3 is a block diagram illustrating and example of applying responsible gaming in a gaming environment while maintaining privacy for player information according to another embodiment of the present disclosure. More specifically, this example illustrates the handling of a second query type, i.e., a query involving retrieval of the banned player information 140. In this case the PSI protocol can be used between the requesting systems 205, i.e., the gaming system 105 or gaming venue system 120, and the responsible gaming system 130. Here, the responsible gaming system 130 acts as the PSI sender while the requesting system(s) 205 act as the PSI receiver.

In this example, the requesting system(s) 205 can issue a query for a particular banned player list or portion of a list. The responsible gaming system 130 can use private set intersection to identify banned player information for the requested list. The responsible gaming system 130 can then respond to the requesting system(s) 205 with the identified list. As noted above, the query and response can signed using a blind RSA signature.

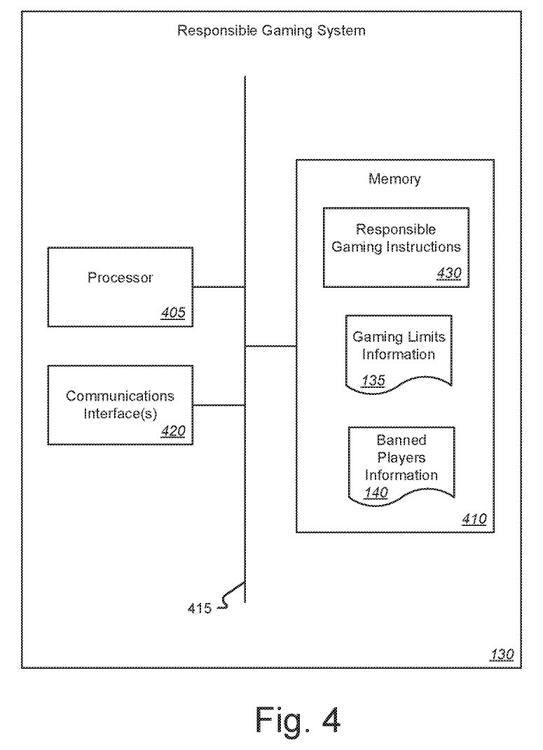

FIG. 4 is a block diagram illustrating additional details of components of an exemplary responsible gaming system according to one embodiment of the present disclosure. As illustrated in this example, a responsible gaming system 130 such as described above can comprise a processor 405. The processor 405 may correspond to one or many computer processing devices. For instance, the processor 405 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 405 may be provided as a microprocessor, Central Processing Unit (CPU), or plurality of microprocessors that are configured to execute the instructions sets stored in a memory 410. Upon executing the instruction sets stored in memory 410, the processor 405 enables various functions of the responsible gaming system 130 as described herein.

The memory 410 can be coupled with and readable by the processor 405 via a communications bus 415. The memory 410 may include any type of computer memory device or collection of computer memory devices. Non-limiting examples of memory 410 include Random Access Memory (RAM), Read Only Memory (ROM), flash memory, Electronically-Erasable Programmable ROM (EEPROM), Dynamic RAM (DRAM), etc. The memory 410 may be configured to store the instruction sets depicted in addition to temporarily storing data for the processor 405 to execute various types of routines or functions.

The processor 405 can also be coupled with one or more communication interface(s) 420. The communication interface(s) 420 can comprise, for example, an Ethernet, Bluetooth, WiFi, cellular, and/or other type of wired and/or wireless communications interface. Via the communication interface(s) 420, the gaming system 105 can communicate with other devices and/or systems through a communications network 115 as described above.

The memory 410 can store therein a set of responsible gaming instructions 430 which, when executed by the processor 405, cause the processor 405 to maintain a first set of responsible gaming information related to a first set of players and maintain a second set of responsible gaming information related to a second set of players. For example, the first set of responsible gaming information can comprise gaming limitation information 135 for each player of the first set of players and the second set of responsible gaming information can comprise a banned player list 140 comprising the second set of players.

The responsible gaming instructions 430 can further cause the processor 405 to receive through the communication interface 420 a first query of a first query type requesting information from the first set of responsible gaming information, i.e., the player gaming limitation information 135, using a first privacy-preserving protocol and respond to the first query through the communication interface with a first answer using the first privacy-preserving protocol. For example, the first privacy-preserving protocol can comprise OT protocol. The first answer can comprise information from the first set of responsible gaming information, i.e., the player gaming limitation information 135.

The responsible gaming instructions 430 can further cause the processor 405 to receive a second query of a second type requesting information from the second set of responsible gaming information, i.e., banned player information 140, using a second protocol and respond to the second query with a second answer using the second privacy-preserving protocol. For example, the second privacy-preserving protocol can comprise PSI protocol. The second answer can comprise information from the second set of responsible gaming information, i.e., banned player information 140. In some cases, the instructions can further cause the processor to sign the first query, the first answer, the second query, and the second answer with a key issued by a certificate authority. For example, the first query, the first answer, the second query, and the second answer can be signed using RSA encryption.

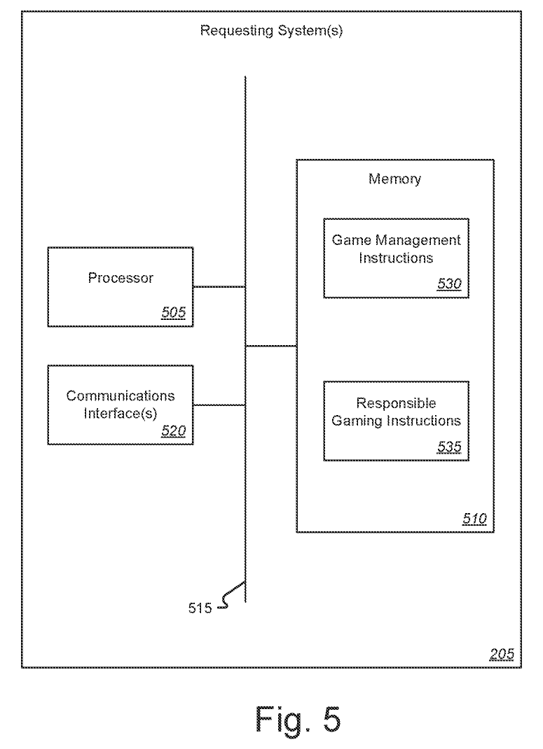

FIG. 5 is a block diagram illustrating additional details of components of an exemplary requesting system according to one embodiment of the present disclosure. As illustrated in this example, a requesting system 205 such as a gaming system 105 or gaming venue system 120 can comprise a processor 505 such as any of the various types of processors described above. A memory 510 can be coupled with and readable by the processor 505 via a communications bus 515. The memory 510 can comprise any one or more of the different types of volatile and/or non-volatile memories described above. The processor 505 can also be coupled with one or more communication interfaces 520 via the communications bus 415. The communication interfaces 520 can comprise, for example, an Ethernet, Bluetooth, WiFi, cellular, and/or other type of wired and/or wireless communications interface.

The memory 510 can store therein a set of game management instructions 530 which, when executed by the processor 505, cause the processor 505 to execute and/or manage one or more electronic games as known in the art. The memory 510 can also store therein a set of responsible gaming instructions 535. The responsible gaming instructions 535, when executed by the processor 505, can cause the processor 505 to issue, via the communication interface 520, a first query of a first query type to a responsible gaming system 130. The first query can be related to a first set of players and can request information from a first set of responsible gaming information using a first privacy-preserving protocol. For example, the first set of responsible gaming information can comprise gaming limitation information 135 for each player of the first set of players and the first privacy-preserving protocol can comprise OT protocol. The responsible gaming instructions 535 can further cause the processor 505 to receive a first answer from the responsible gaming system 130 via the communication interface 520 using the first privacy-preserving protocol, the first answer comprising information from the first set of responsible gaming information.

The responsible gaming instructions 535can further cause the processor 505 to issue, via the communication interface 520, a second query of a second type to the responsible gaming system. The second query can be related to a second set of players and can request information from the second set of responsible gaming information using a second protocol. For example, the second set of responsible gaming information can comprise a banned player list 140 comprising the second set of players and the second privacy-preserving protocol can comprise PSI protocol. The responsible gaming instructions 535 can further cause the processor 505 to receive a second answer from the responsible gaming system 130 via the communication interface 520 using the second privacy-preserving protocol, the second answer comprising information from the second set of responsible gaming information.

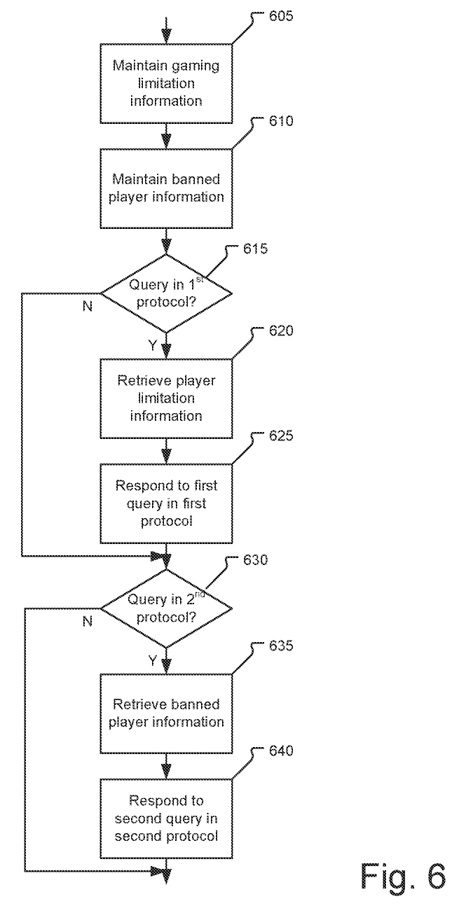

FIG. 6 is a flowchart illustrating an exemplary process for applying responsible gaming in a gaming environment while maintaining privacy for player information according to one embodiment of the present disclosure. As illustrated in this example, preserving privacy in a responsible gaming system as may be performed by a responsible gaming system 130 can comprise maintaining 605 a first set of responsible gaming information related to a first set of players and maintaining 610 a second set of responsible gaming information related to a second set of players. For example, the first set of responsible gaming information can comprise gaming limitation information for each player of the first set of players and the second set of responsible gaming information can comprise a banned player list comprising the second set of players.

A determination 615 can be made as to whether a query of a first query type has been received. The first query can request information from the first set of responsible gaming information using a first privacy-preserving protocol. For example, the first privacy-preserving protocol can comprise Oblivious Transfer (OT) protocol. In response to determining 615 the query of the first query type has been received, information from the first set of responsible gaming information, e.g., gaming limitation information for a player identified in the request, can be retrieved 620 utilizing PIR and PSI to identify the requested set of information and a response can be made 625 to the first query with a first answer using the first privacy-preserving protocol.

A determination 630 can be made as to whether a query of a first query type has been received. The second query can request information from the second set of responsible gaming information using a second protocol. For example, the second privacy-preserving protocol comprises PSI protocol. In response to determining 630 the query of the second query type has been received, information from the second set of responsible gaming information, e.g., a banned players list, can be retrieved 635 utilizing PIR and PSI to identify the requested set of information and a response can be made 640 to the second query with a second answer using the second privacy-preserving protocol.

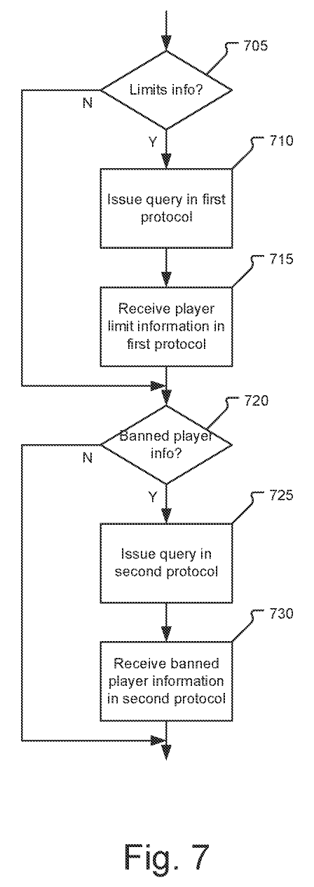

FIG. 7 is a flowchart illustrating an exemplary process for applying responsible gaming in a gaming environment while maintaining privacy for player information according to another embodiment of the present disclosure. As illustrated in this example, applying responsible gaming in a gaming environment while maintaining privacy for player information as may be performed by a gaming venue system 120 and/or gaming system 105 can comprise determining 705 whether to request player gaming limitation information. In response to determining 705 to request player gaming limit information, a query of a first query type can be issued 710 to a responsible gaming system 130. The query can request player gaming limitation information using a first privacy-preserving protocol. For example, the first privacy-preserving protocol can comprise OT protocol. An answer can be received 715 from the responsible gaming system 130 using the first privacy-preserving protocol, the answer comprising information from the first set of responsible gaming information, i.e., the player gaming limitation information.

Additionally, or alternatively, a determination 720 can be made as to whether to request banned player information. In response to determining 720 to request banned player information, a query of a first query type can be issued 725 to a responsible gaming system 130. The query can request banned player information using a second privacy-preserving protocol. For example, the second privacy-preserving protocol can comprise PSI protocol. An answer can be received 730 from the responsible gaming system 130 using the second privacy-preserving protocol, the answer comprising information from the first set of responsible gaming information, i.e., the banned player information.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Patent No. 8,764,566, entitled “Internet Remote Game Server,” and U.S. Patent No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for preserving privacy in a responsible gaming system, the method comprising:
maintaining, by the responsible gaming system, a first set of responsible gaming information related to a first set of players;
maintaining, by the responsible gaming system, a second set of responsible gaming information related to a second set of players;
receiving, by the responsible gaming system, a first query of a first query type, the first query requesting information from the first set of responsible gaming information using a first privacy-preserving protocol;
responding, by the responsible gaming system, to the first query with a first answer using the first privacy-preserving protocol, the first answer comprising information from the first set of responsible gaming information;
receiving, by the responsible gaming system, a second query of a second type, the second query requesting information from the second set of responsible gaming information using a second protocol; and
responding, by the responsible gaming system, to the second query with a second answer using the second privacy-preserving protocol, the second answer comprising information from the second set of responsible gaming information.

2. The method of claim 1, wherein the first set of responsible gaming information comprise gaming limitation information for each player of the first set of players.

3. The method of claim 2, wherein the first privacy-preserving protocol comprises Oblivious Transfer (OT) protocol.

4. The method of claim 1, wherein the second set of responsible gaming information comprises a banned player list comprising the second set of players.

5. The method of claim 4, wherein the second privacy-preserving protocol comprises Private Set Intersection (PSI) protocol.

6. The method of claim 1, wherein the first query, the first answer, the second query, and the second answer are signed with a key issued by a certificate authority.

7. The method of claim 6, wherein the first query, the first answer, the second query, and the second answer are signed using Blind Rivest–Shamir–Adleman (RSA) encryption.

8. A system comprising:
a processor; and
a memory coupled with and readable by the processor and storing therein a set of instructions which, when executed by the processor, causes the processor to:
maintain a first set of responsible gaming information related to a first set of players;
maintain a second set of responsible gaming information related to a second set of players;
receive a first query of a first query type, the first query requesting information from the first set of responsible gaming information using a first privacy-preserving protocol;
respond to the first query with a first answer using the first privacy-preserving protocol, the first answer comprising information from the first set of responsible gaming information;
receive a second query of a second type, the second query requesting information from the second set of responsible gaming information using a second protocol; and
respond to the second query with a second answer using the second privacy-preserving protocol, the second answer comprising information from the second set of responsible gaming information.

9. The system of claim 8, wherein the first set of responsible gaming information comprise gaming limitation information for each player of the first set of players.

10. The system of claim 9, wherein the first privacy-preserving protocol comprises Oblivious Transfer (OT) protocol.

11. The system of claim 8, wherein the second set of responsible gaming information comprises a banned player list comprising the second set of players.

12. The system of claim 11, wherein the second privacy-preserving protocol comprises Private Set Intersection (PSI) protocol.

13. The system of claim 8, wherein the first query, the first answer, the second query, and the second answer are signed with a key issued by a certificate authority.

14. The system of claim 13, wherein the first query, the first answer, the second query, and the second answer are signed using Blind Rivest–Shamir–Adleman (RSA) encryption.

15. A gaming system comprising:
a communication interface;
a processor coupled with the communication interface; and
a memory coupled with and readable by the processor and storing therein a set of instructions which, when executed by the processor, causes the processor to:
issue, via the communication interface, a first query of a first query type to a responsible gaming system, the first query related to a first set of players and requesting information from a first set of responsible gaming information using a first privacy-preserving protocol;
receive a first answer from the responsible gaming system via the communication interface using the first privacy-preserving protocol, the first answer comprising information from the first set of responsible gaming information;
issue, via the communication interface, a second query of a second type to the responsible gaming system, the second query related to a second set of players and requesting information from the second set of responsible gaming information using a second protocol; and
receive a second answer from the responsible gaming system via the communication interface using the second privacy-preserving protocol, the second answer comprising information from the second set of responsible gaming information.

16. The gaming system of claim 15, wherein the first set of responsible gaming information comprise gaming limitation information for each player of the first set of players.

17. The gaming system of claim 16, wherein the first privacy-preserving protocol comprises Oblivious Transfer (OT) protocol.

18. The gaming system of claim 15, wherein the second set of responsible gaming information comprises a banned player list comprising the second set of players.

19. The gaming system of claim 18, wherein the second privacy-preserving protocol comprises Private Set Intersection (PSI) protocol.

20. The gaming system of claim 15, wherein the first query, the first answer, the second query, and the second answer are signed with a key issued by a certificate authority using Blind Rivest–Shamir–Adleman (RSA) encryption.
